(19) United States
(12) Patent Application Publication
(10) Pub. No.: US 2025/0024351 A1
(43) Pub. Date: Jan. 16, 2025

(54) WIRELESS COMMUNICATION SYSTEM, WIRELESS COMMUNICATION METHOD, CONTROL DEVICE, AND CONTROL PROGRAM

(71) Applicant: NIPPON TELEGRAPH AND TELEPHONE CORPORATION, Tokyo (JP)

(72) Inventors: Junichi IWATANI, Tokyo (JP); Yusuke ASAI, Tokyo (JP); Akira KISHIDA, Tokyo (JP); Shinya OTSUKI, Tokyo (JP); Riku OMIYA, Tokyo (JP); Yasushi TAKATORI, Tokyo (JP)

(73) Assignee: NIPPON TELEGRAPH AND TELEPHONE CORPORATION, Tokyo (JP)

(21) Appl. No.: 18/710,185

(22) PCT Filed: Dec. 1, 2021
(86) PCT No.: PCT/JP2021/044110

§ 371 Date: May 15, 2024

(51) Int. Cl. H04W 48/06; H04W 28/08; H04W 84/12

(52) U.S. Cl. CPC H04W 48/06; H04W 28/08; H04W 84/12

(57) ABSTRACT

A wireless communication system includes a multi-device-compatible base station to mixedly accommodate one or more first wireless terminals capable of performing simultaneous communication by a plurality of different communication schemes. There is a control device configured to control the base station. The control device includes a collection unit that collects scheme information regarding the communication schemes by which the first wireless terminals are able to perform communication and scheme information regarding the communication schemes by which the second wireless terminals are able to perform communication. There is also a distribution control unit that controls distribution of traffic.

### TECHNICAL FIELD

The present invention relates to a wireless communication system, a wireless communication method, a control device, and a control program.

### BACKGROUND ART

For example, in IEEE 802.11 (wireless LAN), a function of installing a plurality of different wireless LAN interfaces in one device and establishing a plurality of transmission paths is adopted. Such a device is called a multi-link device (MLD) (see, for example, Non Patent Literature 1). However, in communication between MLDs, there is no particularly clear regulation on distribution of traffic among the plurality of wireless LAN interfaces.

### CITATION LIST

### Non Patent Literature

Non Patent Literature 1: EVGENY KHOROV et al., “Current Status and Directions of IEEE 802.11be, the Future Wi-Fi 7”, IEEE Access, VOLUME 8, 2020, Received Apr. 15, 2020, accepted May 1, 2020, date of publication May 8, 2020, date of current version May 21, 2020., pp. 88664-88688

### SUMMARY OF INVENTION

### Technical Problem

However, in wireless communication between a base station that accommodates a plurality of devices corresponding to different communication schemes (multi-device-compatible) and is capable of simultaneous transmission for each device and a wireless terminal under the base station, a case where a multi-device-compatible wireless terminal and a wireless terminal compatible with only some of the communication schemes are mixed can be assumed.

In this case, the multi-device-compatible wireless terminal can adjust distribution of traffic by using a plurality of communication schemes. On the other hand, there is a possibility that a sufficient communication speed cannot be obtained for a wireless terminal that supports only some communication schemes due to restriction of available communication schemes.

The present invention has been devised in view of the above-described problems, and an object of the present invention is to provide a wireless communication system, a wireless communication method, a control device, and a control program capable of accurately controlling distribution of traffic of each wireless terminal to a multi-device-compatible base station even when wireless terminals capable of performing simultaneous communication by a plurality of different communication schemes and wireless terminals capable of performing communication only by limited communication schemes are mixed.

### Solution to Problem

According to an embodiment of the present invention, a wireless communication system includes: a multi-device-compatible base station configured to mixedly accommodate one or more first wireless terminals capable of performing simultaneous communication by a plurality of different communication schemes and one or more second wireless terminals capable of performing communication only by communication schemes limited to a smaller number than the number of communication schemes of the first wireless terminals; and a control device configured to control the base station.

The control device includes: a collection unit that collects scheme information regarding the communication schemes by which the first wireless terminals are able to perform communication and scheme information regarding the communication schemes by which the second wireless terminals are able to perform communication, and a distribution control unit that controls distribution of traffic to be communicated by each of a plurality of communication schemes by which the first wireless terminals are able to perform communication, based on each piece of scheme information collected by the collection unit.

According to another embodiment of the present invention, a wireless communication method involves controlling a multi-device-compatible base station that mixedly accommodates one or more first wireless terminals capable of performing simultaneous communication by a plurality of different communication schemes and one or more second wireless terminals capable of performing communication only by communication schemes limited to a smaller number than the number of communication schemes of the first wireless terminals. The method includes: a collection step of collecting scheme information regarding the communication schemes by which the first wireless terminals are able to perform communication and scheme information regarding the communication schemes by which the second wireless terminals are able to perform communication; and a distribution control step of controlling distribution of traffic to be communicated by each of a plurality of communication schemes by which the first wireless terminals are able to perform communication based on each piece of collected scheme information.

According to still another embodiment of the present invention, a control device controls a multi-device-compatible base station that mixedly accommodates one or more first wireless terminals capable of performing simultaneous communication by a plurality of different communication schemes and one or more second wireless terminals capable of performing communication only by communication schemes limited to a smaller number than the number of communication schemes of the first wireless terminals.

The control device includes: a collection unit that collects scheme information regarding the communication schemes by which the first wireless terminals are able to perform communication and scheme information regarding the communication schemes by which the second wireless terminals are able to perform communication, and a distribution control unit that controls distribution of traffic to be communicated by each of a plurality of communication schemes by which the first wireless terminals are able to perform communication, based on each piece of scheme information collected by the collection unit.

### Advantageous Effects of Invention

According to the present invention, even when wireless terminals capable of performing simultaneous communication by a plurality of different communication schemes and wireless terminals capable of performing communication only by limited communication schemes are mixed, it is possible to accurately control distribution of traffic of each wireless terminal to a multi-device-compatible base station.

### BRIEF DESCRIPTION OF DRAWINGS

FIG. 1 is a diagram illustrating a configuration example of a wireless communication system according to an embodiment.

FIG. 2 is a diagram illustrating a specific configuration example of a base station.

FIG. 3 is a diagram illustrating a specific configuration example of a control device according to an embodiment.

FIG. 4 is a diagram illustrating a result obtained when the control device controls the base station in a second operation example of the wireless communication system.

FIG. 5 is a diagram illustrating a result obtained when the control device controls the base station in a third operation example of the wireless communication system.

FIG. 6 is a diagram illustrating another example of a method (fourth operation example) in which the wireless communication system allocates wireless resources.

FIG. 7 is a diagram illustrating a result obtained when a control device controls a base station in a fifth operation example of the wireless communication system.

FIG. 8 is a flowchart illustrating an operation example of the control device.

FIG. 9 is a flowchart illustrating another operation example of the control device.

FIG. 10 is a diagram illustrating a hardware configuration example of a control device.

FIG. 11 is a diagram illustrating a configuration example of a wireless communication system according to a comparative example in which a multi-device-compatible base station is included.

### DESCRIPTION OF EMBODIMENTS

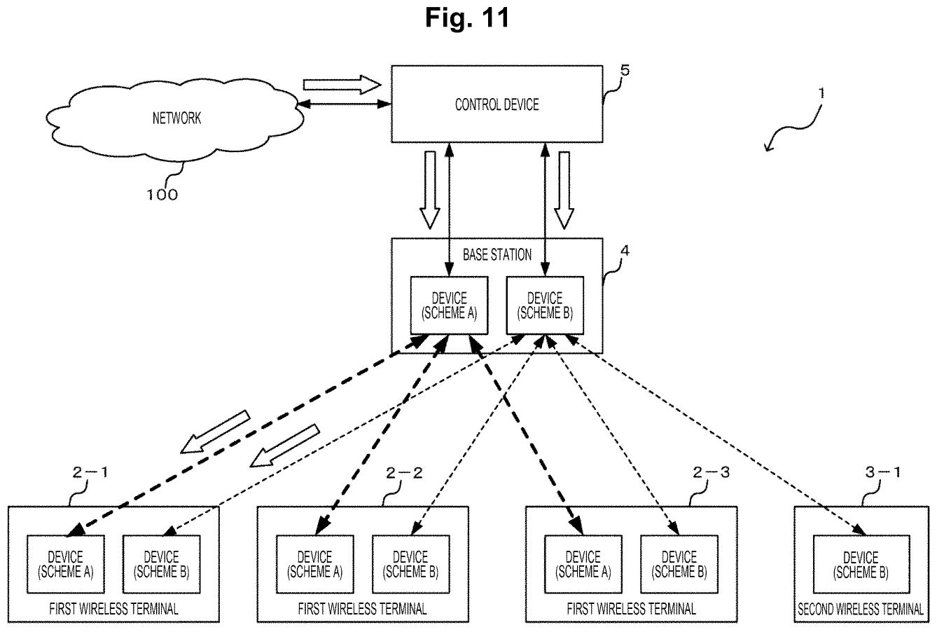

First, the background of the present invention will be described. FIG. 11 is a diagram illustrating a configuration example of a wireless communication system 1 according to a comparative example in which a multi-device-compatible base station is included. As illustrated in FIG. 11, the wireless communication system 1 according to the comparative example includes a base station 4 accommodating first wireless terminals 2-1 to 2-3 and a second wireless terminal 3-1, and a control device 5.

Each of the first wireless terminals 2-1 to 2-3 is a multi-device-compatible wireless terminal including a plurality of devices corresponding to communication schemes (schemes A and B) of a plurality of devices included in the multi-device-compatible base station 4.

The second wireless terminal 3-1 is a wireless terminal including a device corresponding to only some (scheme B) of the communication schemes of a plurality of devices included in the base station 4.

The control device 5 is connected to the network 100 and controls the base station 4 such that the base station 4 performs wireless communication with each of the first wireless terminals 2-1 to 2-3 and the second wireless terminal 3-1.

At this time, for example, traffic from the base station 4 to each of the multi-device-compatible first wireless terminals 2-1 to 2-3 is distributed using the schemes A and B.

However, in the wireless communication system 1 according to the comparative example, there is no particular regulation for distributing traffic to each of the first wireless terminals 2-1 to 2-3. For example, it is assumed that traffic is simply distributed to each of the first wireless terminals 2-1 to 2-3 so that the distributed traffic is proportional to a frequency bandwidth of each of the schemes A and B.

In this case, in the distribution of wireless resources to each of the first wireless terminals 2-1 to 2-3 and the second wireless terminal 3-1, fairness between the terminals is not guaranteed. For example, when a bandwidth of scheme B is small, wireless resourced for the second wireless terminal 3-1 corresponding only to the scheme B become considerably small.

Accordingly, a wireless communication system 10 according to an embodiment to be subsequently described is configured to be able to accurately control distribution of traffic of each wireless terminal to a multi-device-compatible base station.

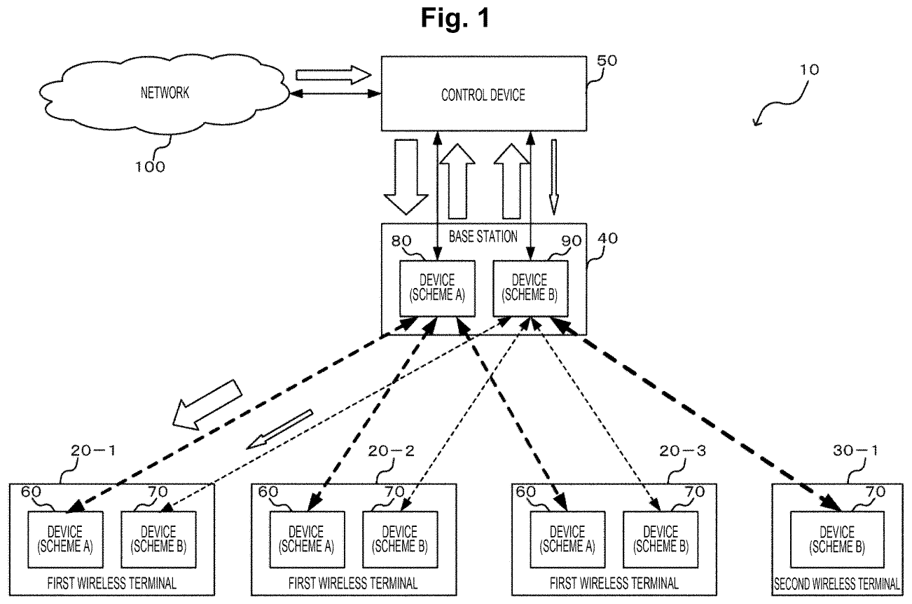

Hereinafter, a configuration example of the wireless communication system 10 according to an embodiment will be described with reference to the drawings. FIG. 1 is a diagram illustrating a configuration example of the wireless communication system 10 according to an embodiment.

As illustrated in FIG. 1, the wireless communication system 10 according to an embodiment includes a multi-device-compatible base station 40 that accommodates first wireless terminals 20-1 to 20-3 and a second wireless terminal 30-1, and a control device 50.

The control device 50 is connected to the network 100 and controls the base station 40 such that the base station 40 performs wireless communication with the first wireless terminals 20-1 to 20-3 and the second wireless terminal 30-1.

The base station 40 is a multi-device compatible device, includes a device 80 serving as an access point (AP) of the scheme A and a device 90 serving as an AP of the scheme B, and performs wireless communication with each of the first wireless terminals 20-1 to 20-3 and the second wireless terminal 30-1 under the control of the control device 50.

The scheme A is, for example, a 6 GHz band wireless communication scheme in IEEE 802.11 (wireless LAN). The scheme B is, for example, a 5 GHz band wireless communication scheme in IEEE 802.11 (wireless LAN). In a multi-device compatible device, wireless communication can be performed by using the schemes A and B simultaneously.

Each of the first wireless terminals 20-1 to 20-3 is a multi-device-compatible wireless terminal (STA) including devices 60 and 70 corresponding to communication schemes (the scheme A and scheme B) of the devices 80 and 90 included in the multi-device-compatible base station 40 corresponding to both 6 GHZ and 5 GHZ bands. When a particular one of a plurality of configurations such as the first wireless terminals 20-1 to 20-3 is not specified, the wireless terminals are simply referred to as the first wireless terminals 20 or the like.

The device 60 corresponds to a communication scheme (the scheme A) of the device 80 included in the base station 40 and performs wireless communication with the device 80. The device 70 corresponds to the communication scheme (the scheme B) of the device 90 included in the base station 40 and performs wireless communication with the device 90.

The second wireless terminal 30-1 is a wireless terminal including the device 70 corresponding to only some (the scheme B) of the communication schemes (the scheme A and scheme B) of the devices 80 and 90 included in the base station 40. For example, in the second wireless terminal 30-1, the device 70 corresponding to only the 5 GHz band performs wireless communication with the device 90 of the base station 40.

Then, the base station 40 collects scheme information regarding a wireless communication scheme by which each of the first wireless terminals 20-1 to 20-3 and the second wireless terminal 30-1 can communicate, and transmits the scheme information to the control device 50.

That is, the wireless communication system 1 is a communication system including the multi-device-compatible base station 40 that mixedly accommodates one or more first wireless terminals 20 capable of performing simultaneous communication by a plurality of different communication schemes and one or more second wireless terminals 30 capable of performing communication only by communication schemes limited to a smaller number than the number of communication schemes of the first wireless terminals 20, and the control device 50 that controls the base station 40.

As a first operation example of the wireless communication system 1, the control device 50 controls a distribution ratio of traffic between the devices addressed to the first wireless terminals 20-1 to 20-3 based on the scheme information regarding each of the first wireless terminals 20-1 to 20-3 and the second wireless terminal 30-1 collected via the base station 40 and predetermined fairness (equal distribution), a priority, or the like between the wireless terminals and the devices.

For example, in devices that perform wireless communication by the scheme B, a large amount of traffic is secured for the second wireless terminal 30-1 that cannot use the wireless communication by the scheme A in combination. That is, the control device 50 performs control such that the distribution of the wireless communication is more in accordance with the scheme A for the multi-device-compatible wireless terminal.

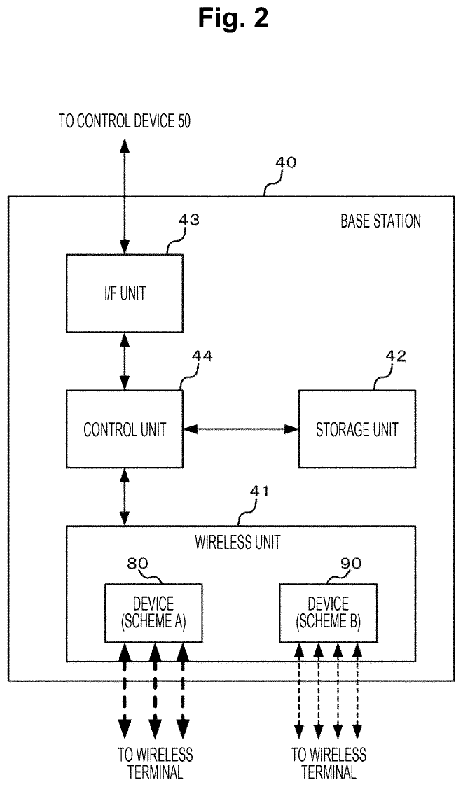

Next, a specific configuration example of the base station 40 will be described. FIG. 2 is a diagram illustrating a specific configuration example of the base station 40. As illustrated in FIG. 2, the base station 40 includes, for example, a wireless unit 41, a storage unit 42, an interface (I/F) unit 43, and a control unit 44.

The wireless unit 41 includes the above-described devices 80 and 90 and performs wireless communication with each of the first wireless terminals 20-1 to 20-3 and the second wireless terminal 30-1.

The storage unit 42 stores information or the like received by the base station 40 via the wireless unit 41 or the I/F unit 43.

The I/F unit 43 is a communication interface that performs communication with the control device 50.

The control unit 44 controls each unit included in the base station 40.

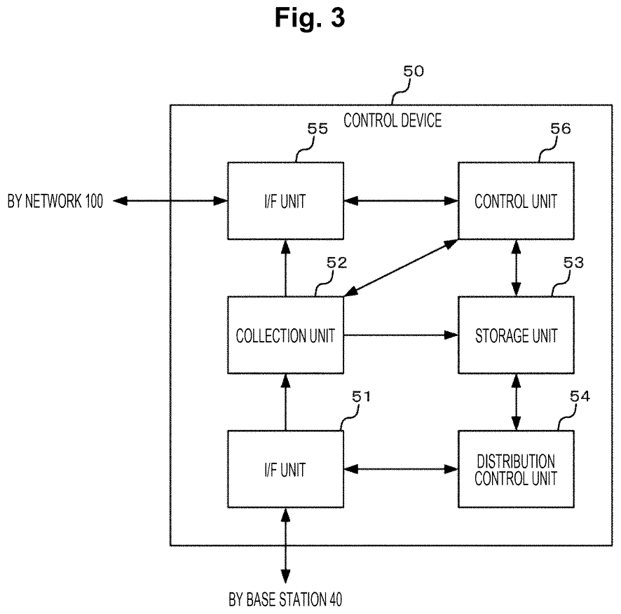

Next, a specific configuration example of the control device 50 will be described. FIG. 3 is a diagram illustrating a specific configuration example of the control device 50 according to the embodiment. As illustrated in FIG. 3, the control device 50 includes, for example, an interface (I/F) unit 51, a collection unit 52, a storage unit 53, a distribution control unit 54, an interface (I/F) unit 55, and a control unit 56.

The I/F unit 51 is a communication interface that communicates with the base station 40.

The collection unit 52 collects, for example, scheme information regarding a communication scheme in which the first wireless terminals 20-1 to 20-3 can communicate and scheme information regarding a communication scheme by which the second wireless terminal 30-1 can perform communication via the I/F unit 51, and outputs the scheme information to the storage unit 53 and the I/F unit 55.

The collection unit 52 may collect a product of a frequency bandwidth and an air time rate or the traffic to be communicated per hour for each communication scheme as the scheme information.

The storage unit 53 stores, for example, the scheme information collected by the collection unit 52.

The distribution control unit 54 reads the scheme information collected by the collection unit 52 from the storage unit 53, for example, and controls the distribution of the traffic to be communicated by each of the plurality of communication schemes that the first wireless terminals 20-1 to 20-3 can communicate with based on each of the scheme information collected by the collection unit 52.

More specifically, after the distribution of the traffic to be communicated by the communication scheme by which the second wireless terminal 30-1 can perform communication is ensured, the distribution control unit 54 controls the distribution of the traffic to be communicated by each of the plurality of communication schemes by which the first wireless terminals 20-1 to 20-3 can perform communication.

The distribution control unit 54 may control the distribution of the traffic so that at least one of the first wireless terminals 20-1 to 20-3 and the second wireless terminal 30-1 performs shaping.

That is, the distribution control unit 54 controls the first wireless terminals 20-1 to 20-3 and the second wireless terminal 30-1 via the I/F unit 51.

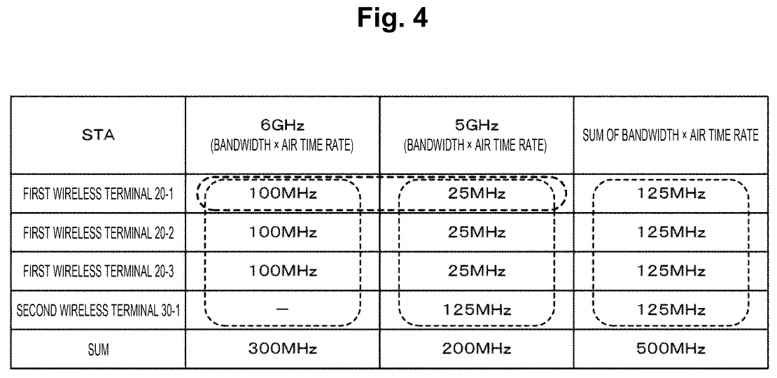

Next, a second operation example of the wireless communication system 1 will be described. FIG. 4 is a diagram illustrating a result obtained when the control device 50 controls the base station 40 in the second operation example of the wireless communication system 1. Here, 300 MHz is set in the 6 GHz band, 200 MHz is set in the 5 GHz band, and a total of 500 MHz is set in the base station 40.

First, the control device 50 distributes wireless resources to the respective wireless terminals based on the total bandwidth of the devices included in the base station 40 so that a sum of “bandwidth x air time rate” becomes equal as the wireless resources of the wireless terminals.

Next, the control device 50 allocates a wireless resource of a corresponding device to the second wireless terminal 30-1 corresponding only to the scheme B.

Next, the control device 50 allocates the remaining wireless resources to the first wireless terminals 20-1 to 20-3. At this time, the control device 50 equally allocates the wireless resources to the first wireless terminals 20-1 to 20-3.

As an operation in the second operation example of the wireless communication system 1, the control device 50 ensures fairness of wireless resources for the first wireless terminals 20-1 to 20-3 and the second wireless terminal 30-1.

That is, the control device 50 causes the distribution of the traffic of the devices of the first wireless terminals 20-1 to 20-3 to be proportional to the ratio of the numerical value of the bandwidth of the 6 GHZ band x the air time rate.

Then, the control device 50 causes the wireless air time rate in each device to be proportional to the numerical value of bandwidth x the air time rate of each of the first wireless terminals 20-1 to 20-3 and the second wireless terminal 30-1.

As a result, the control device 50 equally distributes the wireless resources of the 6 GHZ and 5 GHZ bands to the first wireless terminals 20-1 to 20-3, and distributes only the 5 GHz band to the second wireless terminal 30-1. In this way, the control device 50 determines distribution ratios of the wireless resources to the devices of the first wireless terminals 20-1 to 20-3 and the second wireless terminal 30-1. When the traffic in which each of the first wireless terminals 20-1 to 20-3 is set as a transmission destination is distributed to the available devices, the control device 50 distributes an amount of data proportional to the numerical value of the wireless resource (bandwidth x air time rate) described above.

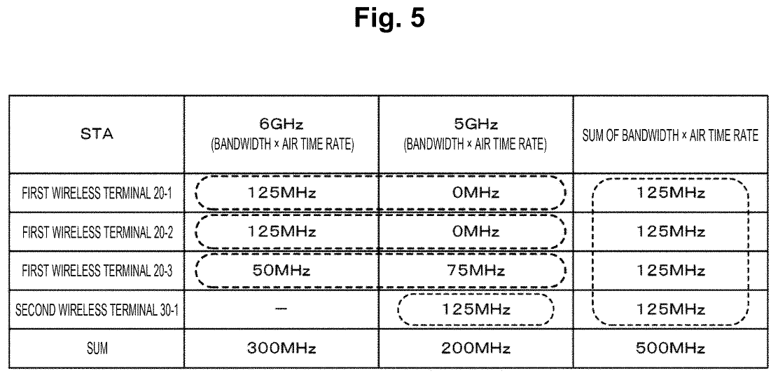

Next, a third operation example of the wireless communication system 1 will be described. FIG. 5 is a diagram illustrating a result obtained when the control device 50 controls the base station 40 in the third operation example of the wireless communication system 1. Here, the distribution of wireless resources is different among the devices of the first wireless terminals 20-1 to 20-3. Here, 300 MHz is set in the 6 GHz band, 200 MHz is set in the 5 GHz band, and a total of 500 MHz is set in the base station 40.

First, the control device 50 distributes wireless resources to the respective wireless terminals based on the total bandwidth of the devices included in the base station 40 so that a sum of “bandwidth x air time rate” becomes equal as the wireless resources of the wireless terminals.

Next, the control device 50 allocates a wireless resource of a corresponding device to the second wireless terminal 30-1 corresponding only to the scheme B.

Next, the control device 50 allocates the remaining wireless resources to the first wireless terminals 20-1 to 20-3. At this time, the control device 50 allocates a different wireless resource to each of the first wireless terminals 20-1 to 20-3 according to, for example, a predetermined priority (efficiency) or the like.

For example, it is assumed that the control device 50 allocates only the 6 GHz band to the first wireless terminals 20-1 and 20-2 (does not use the 5 GHz band), so that only two of the first wireless terminal 20-3 and the second wireless terminal 30-1 use the 5 GHz band.

As a result, the control device 50 equally distributes the wireless resources to the first wireless terminals 20-1 to 20-3, and distributes only the 5 GHz band to the second wireless terminal 30-1. However, the control device 50 distributes different wireless resources to the devices of the 6 GHz band of each of the first wireless terminals 20-1 to 20-3.

Accordingly, the wireless communication system 1 can reduce a processing load of the device in the 5 GHz band and implement high efficiency by reducing an overhead of wireless transmission. The control device 50 distributes the amount of data proportional to the numerical value of the above-described wireless resource when allocating the traffic in which each of the first wireless terminals 20-1 to 20-3 is set as a transmission destination to the available device.

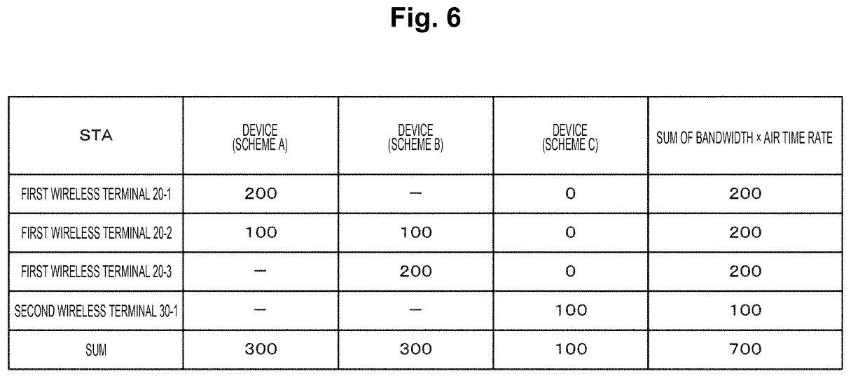

FIG. 6 is a diagram illustrating another example of a method (fourth operation example) in which the wireless communication system 1 allocates wireless resources. In FIG. 6, “-” indicates unavailability, and a unit is MHz. The wireless communication system 1 can distribute various wireless resources according to the number of devices, the number of wireless terminals, and the devices (communication schemes) available in the wireless terminals.

In the wireless communication system 1, the wireless resources cannot be equally distributed to wireless terminals in some cases. For example, there are wireless terminals corresponding to only some devices (wireless communication schemes), and wireless resources of the devices are small.

In this case, the control device 50 may prioritize wireless terminals having many restrictions for distributing wireless resources and equalize the distribution of the wireless resources among the wireless terminals as much as possible while sequentially determining the distribution of the wireless resources.

For example, as illustrated in FIG. 6, when wireless resources are equalized among wireless terminals, the control device 50 divides a total of 700 MHZ of the bandwidth x the air time rate into four equal frequencies and sets the equal frequencies to 175 MHz.

The second wireless terminal 30-1 can perform communication with only a device in conformity with the scheme C (a total of 100 MHZ), and the maximum frequency is 100 MHz. At this time, the wireless resources cannot be equally distributed.

First, the control device 50 pre-allocates the wireless resource to the second wireless terminal 30-1. That is, the control device 50 allocates the device in conformity with the scheme C (a total of 100 MHZ) to the second wireless terminal 30-1.

Subsequently, the control device 50 distributes the remaining (700−100=600) wireless resources equally (200 each) by the first wireless terminals 20-1 to 20-3 other than the second wireless terminal 30-1.

Subsequently, since the device in conformity with the scheme C has been already allocated to the second wireless terminal 30-1, the control device 50 sets the distribution of the device in conformity with the scheme C to 0 with respect to the first wireless terminals 20-1 and 20-3 restricted in the wireless communication scheme.

At this time, the control device 50 equally (200 each) distributes the devices in conformity with the scheme A and the devices in conformity with the scheme B to the first wireless terminals 20-1 and 20-3.

Then, the control device 50 allocates the remaining wireless resources to the first wireless terminal 20-2 having no restriction on the wireless communication scheme. The control device 50 distributes the amount of data proportional to the numerical value of the above-described wireless resource when allocating the traffic in which each of the first wireless terminals 20-1 to 20-3 is set as a transmission destination to the available device.

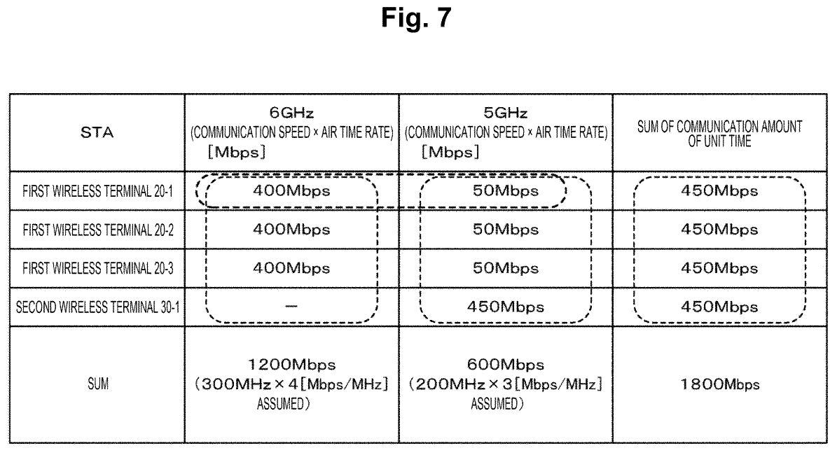

Next, a fifth operation example of the wireless communication system 1 will be described. FIG. 7 is a diagram illustrating a result obtained when the control device 50 controls the base station 40 in the fifth operation example of the wireless communication system 1. Here, 1200 Mbps is set in the 6 GHz band, 600 Mbps is set in the 5 GHz band, and a total of 1800 Mbps is set in the base station 40. It is assumed that Mbps/MHz (=equivalent to MCS) is also the same in the base station 40.

First, the control device 50 applies “communication speed x air time rate” (based on the communication amount of the unit time) instead of the above-described “bandwidth x air time rate” as the wireless resource.

First, the control device 50 distributes the wireless resources to the wireless terminals such that a sum of “communication speed x air time rate” becomes equal as the wireless resources of the wireless terminals based on a communication amount (a communication speed) in a unit time of each device included in the base station 40.

Next, the control device 50 allocates a wireless resource of a corresponding device to the second wireless terminal 30-1 corresponding only to the scheme B.

Next, the control device 50 allocates the remaining wireless resources to the first wireless terminals 20-1 to 20-3. At this time, the control device 50 equally allocates the wireless resources to the first wireless terminals 20-1 to 20-3.

As an operation in the fifth operation example of the wireless communication system 1, the control device 50 ensures fairness of the wireless resource for each of the first wireless terminals 20-1 to 20-3 and the second wireless terminal 30-1.

That is, the control device 50 causes the distribution of the traffic of each device of the first wireless terminals 20-1 to 20-3 to be proportional to the ratio of the numerical values of the communication speed in the 6 GHz band.

The control device 50 causes the wireless air time rate in each device to be proportional to a ratio of a numerical values of a communication speed in the 5 GHz band of each wireless terminal.

That is, the control device 50 equally distributes the wireless resources among the wireless terminals. The control device 50 distributes only the 5 GHz band to the second wireless terminal 30-1. The control device 50 equally distributes the remaining wireless resources to the first wireless terminals 20-1 to 20-3. The control device 50 distributes the amount of data proportional to the numerical value of the above-described wireless resource when allocating the traffic in which each of the first wireless terminals 20-1 to 20-3 is set as a transmission destination to the available device.

For the control device 50, the base station 40 may notify the control device 50 of the communication amount (allowable value) in the unit time of each device and each wireless terminal.

When the communication amount directed for each device and the wireless terminal is close to a predetermined upper limit, the control device 50 may perform shaping to limit a flow rate of traffic to the base station 40. For example, in order to prioritize some wireless terminals in the device, the base station 40 shapes the traffic directed for other wireless terminals to inhibit the flow rate.

When the communication amount of some wireless terminals is small in the device of the base station 40, the control device 50 may allocate a large surplus to other wireless terminals.

For example, when the traffic directed for the first wireless terminal 20-1 is prioritized, the 5 GHz band of the first wireless terminal 20-1 is set to 110 Mbps, the 5 GHz band of the first wireless terminal 20-2 is set to 30 Mbps, the 5 GHz band of the first wireless terminal 20-3 is set to 30 Mbps, and the 5 GHz band of the second wireless terminal 30-1 is set to 430 Mbps.

That is, the control device 50 decreases the flow rate of the traffic of other wireless terminals in order to prioritize the traffic directed for the first wireless terminal 20-1 in the device of the 5 GHz band. Conversely, when the inflow of traffic directed for the first wireless terminal 20-1 is small in the device of the 5 GHz band, the control device 50 can also allocate the surplus to the first wireless terminals 20-2 and 20-3 and the second wireless terminal 30-1.

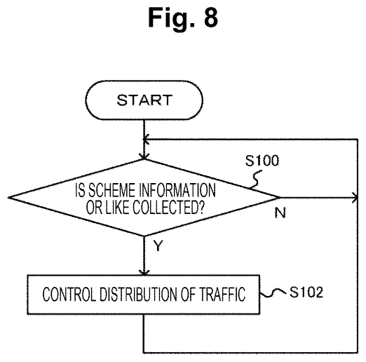

Next, an operation example of the control device 50 will be described. FIG. 8 is a flowchart illustrating an operation example of the control device 50. As illustrated in FIG. 8, the control device 50 determines whether the scheme information of each wireless terminal is collected (S100). When the scheme information is not collected (No in S100:) the process of S100 is repeated. When the scheme information is collected (Yes in S100), the process moves to the process of S102.

In the process of S102, the control device 50 controls the distribution of the traffic and returns to the process of S100.

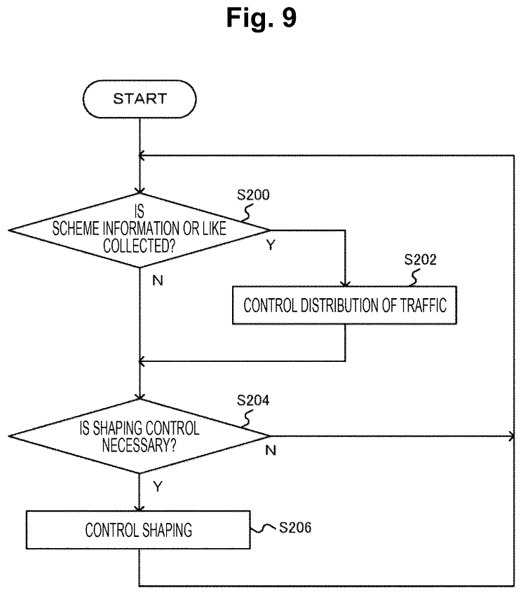

FIG. 9 is a flowchart illustrating another operation example of the control device 50. As illustrated in FIG. 9, the control device 50 determines whether the scheme information of each wireless terminal is collected (S200). When the scheme information is not collected (No in S200), the process moves to S204. When the scheme information is collected (Yes in S200), the process moves to S202.

In the processing of S202, the control device 50 controls the distribution of the traffic and proceeds to the processing of S204.

Subsequently, the control device 50 determines whether shaping control is necessary in each device (S204). When the shaping control is not necessary (No in S204), the process returns to S200. When the shaping control is necessary (Yes in S204), the process moves to S206.

In the process of S206, the control device 50 performs the shaping control and returns the process to S200.

In this way, the wireless communication system 1 according to the embodiment is capable of accurately controlling distribution of traffic of each wireless terminal to a multi-device-compatible base station even when wireless terminals capable of performing simultaneous communication by a plurality of different communication schemes and wireless terminals capable of performing communication only by limited communication schemes are mixed.

Some or all of the functions of the control device 50 may be configured with hardware such as a programmable logic device (PLD) or a field programmable gate array (FPGA) or may be configured as a program executed by a processor such as a CPU.

For example, the control device 50 can be implemented using a computer and a program, and the program can be recorded in a storage medium or provided through a network.

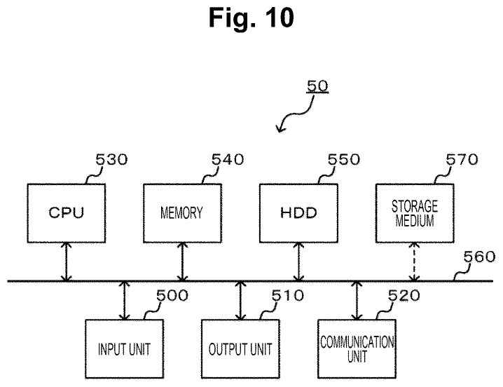

FIG. 10 is a diagram illustrating a hardware configuration example of the control device 50. As illustrated in FIG. 10, the control device 50 has a function of a computer in which an input unit 500, an output unit 510, a communication unit 520, a CPU 530, a memory 540, and an HDD 550 are connected via a bus 560. The control device 50 can input and output data to and from a computer-readable storage medium 570.

The input unit 500 is, for example, a keyboard, a mouse, or the like. The output unit 510 is, for example, a display device such as a display. The communication unit 520 is, for example, a network interface or the like.

The CPU 530 controls each unit included in the control device 50 and performs a predetermined process or the like. The memory 540 and the HDD 550 are storage units that store data or the like.

The storage medium 570 can store a program or the like executing a function of the control device 50. An architecture that configures the control device 50 is not limited to the example illustrated in FIG. 10.

### REFERENCE SIGNS LIST

10 Wireless communication system
20-1 to 20-3 First wireless terminal
30-1 Second wireless terminal
40 Base station
41 Wireless unit
42 Storage unit
43 I/F
44 Control unit
50 Control device
51 I/F
52 Collection unit
53 Storage unit
54 Distribution control unit
55 I/F
56 Control unit
60, 70, 80, 90 Device
100 Network
500 Input unit
510 Output unit
520 Communication unit
530 CPU
540 Memory
550 HDD
560 Bus
570 Storage medium

1. A wireless communication system comprising:
a multi-device-compatible base station configured to mixedly accommodate one or more first wireless terminals capable of performing simultaneous communication by a plurality of different communication schemes and one or more second wireless terminals capable of performing communication only by communication schemes limited to a smaller number than the number of communication schemes of the first wireless terminals; and
control circuitry configured to control the base station,
wherein the control circuitry includes:
collection circuitry configured to collect scheme information regarding the communication schemes by which the first wireless terminals are able to perform communication and scheme information regarding the communication schemes by which the second wireless terminals are able to perform communication, and
distribution control circuitry configured to control distribution of traffic to be communicated by each of a plurality of communication schemes by which the first wireless terminals are able to perform communication, based on each piece of scheme information collected by the collection circuitry.

2. The wireless communication system according to claim 1, wherein:
the distribution control circuitry controls the distribution of the traffic to be communicated by each of a plurality of communication schemes by which the first wireless terminals are able to perform communication after guaranteeing the distribution of the traffic to be communicated by the communication schemes by which the second wireless terminals are able to perform communication.

3. The wireless communication system according to claim 1, wherein:
the collection circuitry collects, as scheme information, a product of a frequency bandwidth and an air time rate or traffic to be communicated per hour for each communication scheme.

4. The wireless communication system according to claim 1, wherein;
the distribution control circuitry controls the distribution of the traffic such that at least one of the first and second wireless terminals performs shaping.

5. A wireless communication method of controlling a multi-device-compatible base station that mixedly accommodates one or more first wireless terminals capable of performing simultaneous communication by a plurality of different communication schemes and one or more second wireless terminals capable of performing communication only by communication schemes limited to a smaller number than the number of communication schemes of the first wireless terminals, the method comprising:
collecting scheme information regarding the communication schemes by which the first wireless terminals are able to perform communication and scheme information regarding the communication schemes by which the second wireless terminals are able to perform communication; and
controlling distribution of traffic to be communicated by each of a plurality of communication schemes by which the first wireless terminals are able to perform communication based on each piece of collected scheme information.

6. The wireless communication method according to claim 5, wherein the controlling distribution further comprises:
controlling the distribution of the traffic to be communicated by each of a plurality of communication schemes by which the first wireless terminals are able to perform communication after guaranteeing the distribution of traffic to be communicated by the communication scheme by which the second wireless terminal are able to perform communication.

7. A control device controlling a multi-device-compatible base station that mixedly accommodates one or more first wireless terminals capable of performing simultaneous communication by a plurality of different communication schemes and one or more second wireless terminals capable of performing communication only by communication schemes limited to a smaller number than the number of communication schemes of the first wireless terminals, the control device comprising:
a collection circuitry that collects scheme information regarding the communication schemes by which the first wireless terminals are able to perform communication and scheme information regarding the communication schemes by which the second wireless terminals are able to perform communication, and
a distribution control circuitry that controls distribution of traffic to be communicated by each of a plurality of communication schemes by which the first wireless terminals are able to perform communication, based on each piece of scheme information collected by the collection circuitry.

8. A non-transitory computer readable medium storing a control program for causing a computer to perform the method of claim 5.
